(19) United States
(12) Patent Application Publication
(10) Pub. No.: US 2025/0054689 A1
(43) Pub. Date: Feb. 13, 2025

(54) SPACER ELEMENT FOR A WINDING, KIT, METHOD FOR MANUFACTURING A WINDING AND WINDING

(71) Applicant: Hitachi Energy Ltd, Zürich (CH)

(72) Inventors: Gianluca Bustreo, Mirano (IT); Valentina Valori, Monselice (IT); Paolo Pavanello, Granze (IT); Lorenzo Luis Prieto Colmenero, Cordoba (ES)

(21) Appl. No.: 18/720,730

(22) PCT Filed: Dec. 2, 2022
(86) PCT No.: PCT/EP2022/084242

§ 371 Date: Jun. 17, 2024

(30) Foreign Application Priority Data
Jan. 5, 2022 (EP) 22382002.8

(51) Int. Cl. H01F 27/32; H01F 41/04

(52) U.S. Cl. CPC H01F 27/322; H01F 27/323; H01F 41/04

(57) ABSTRACT

According to an embodiment, the spacer element for a winding of an electric device includes at least one connection member and a plurality of ribs. The ribs are connected to the connection member and are spaced from each other pairwise. The spacer element is arrangeable between two successive winding units of the winding during manufacturing of the winding. Each two adjacent ribs delimit a flow channel for a cooling fluid, said flow channel extends between and along the two adjacent ribs.

### CROSS-REFERENCE TO RELATED APPLICATIONS

This application is a 35 U.S.C. § 371 national stage application of PCT International Application No. PCT/EP2022/084242 filed on Dec. 2, 2022, which in turn claims priority to European Patent Application No. 22382002.8, filed on Jan. 5, 2022, the disclosures and content of which are incorporated by reference herein in their entireties.

### TECHNICAL FIELD

The present disclosure relates to a spacer element for a winding of an electric device. Moreover, the present disclosure relates to a kit comprising such a winding, a method for manufacturing a winding and a winding for an electric device.

### BACKGROUND

Document DE 42 43 090 C1 discloses a spacer element for a winding. Document EP 0 040 382 A1 discloses a sheet-wound coil for a transformer filled with a liquid dielectric. Document US 2011/163833 A1 relates to a method for making electrical windings for electrical apparatus and transformers and windings obtained by said method. Document JP S57 148322 A relates to a self-cooling stationary inductor coil winding.

### SUMMARY

There is a need for an improved spacer element for a winding, e.g., for a spacer element with which the manufacturing time for manufacturing a winding can be reduced. Moreover, there is a need for a kit with such a spacer element, a method for manufacturing a winding using such a spacer element and a winding with such a spacer element.

Embodiments of the disclosure relate to an improved spacer element. Other embodiments of the present disclosure relate to a kit with such a spacer element, a method for manufacturing a winding using such a spacer element and a winding with such a spacer element.

First, the spacer element for a winding of an electric device is specified. The electric device may be an electromagnetic induction device, like a transformer or power transformer.

According to an embodiment, the spacer element for a winding of an electric device comprises at least one connection member and a plurality of ribs. The ribs are connected to the connection member and are spaced from each other pairwise. The spacer element is arrangeable between two successive winding units of the winding during manufacturing of the winding. Each two adjacent ribs delimit a flow channel for a cooling fluid, said flow channel extends between and along the two adjacent ribs.

With such a spacer element, the manufacturing time for a winding can be reduced. Particularly, there is no need for ribs to be individually placed in order to define flow channels, but a compound of a plurality of ribs defining several flow channels and held together by the connection member can be placed between the winding units in one step. The spacer element allows for an automatization or a partial automatization of the winding process. Such a spacer element can be used in all low voltage and high voltage windings, e.g., where standard spaces are required. Moreover, a vertical alignment of ribs, as is usually done, can be dismissed with such a spacer element. This further reduces the manufacturing effort. Furthermore, the spacer element provides a large support surface for the winding units and, with this, a good distribution of, e.g., short-circuit forces over the winding units is achieved. Moreover, with the flow channels integrated into the spacer element, an increased cooling surface and a better flow distribution of the cooling fluid with the possibility of potential material saving is achieved.

For example, the connection member and/or the ribs may comprise or consist of an electrically isolating material, like plastic or paper or pressboard or a composite or ceramic. The whole spacer element may be electrically isolating, e.g., only comprise of electrically isolating material(s). Thus, the spacer element may be configured for electrically isolating the successive winding units from each other. For instance, the spacer element comprises at least two or at least five or at least 10 ribs. Each rib may be formed as a stick or bar.

The ribs may be connected, e.g., rigidly connected or fixed, to the at least one connection member and may be spaced from each other pairwise. The connections may be a positive substance connection, e.g., an adhesive connection. The at least one connection member may hold the ribs spaced from each other. For example, the at least one connection member mechanically supports the ribs. The at least one connection member may extend over all ribs of the spacer element. The spacer element may comprise several connection members and all features disclosed herein for one connection member are also disclosed for the other connection members.

The ribs may all be shaped identically within the limits of manufacturing tolerances. For instance, the ribs are spaced equidistantly from each other.

Each rib is an elongated member. The length of each rib is, e.g., greater than its width and/or thickness, e.g., at least 5-times or at least 10-times as great as its width and/or thickness. A direction along the longitudinal extension of a rib is called the main extension direction of the rib. The width of each rib is measured in a transverse direction, perpendicular to the main extension direction of this rib, and the thickness is measured in a vertical direction, perpendicular to the main extension direction and the transverse direction of this rib. By way of example, for each rib, the width of the rib is greater than the thickness of the rib, e.g., at least 2-times or at least 5-times or at least 10-times as great as the thickness. By way of example, for each rib an immediate adjacent rib is spaced from the rib in the transverse direction. The minimum distance between each two adjacent ribs may be greater than the widths of the ribs, e.g., at least 2-times or at least 5-times as great.

For instance, the thickness of each rib is in the range between 1 mm and 5 mm, inclusive. The width of each rib may be in the range between 1 mm and 50 mm inclusive, e.g., between 20 mm and 50 mm inclusive. The minimum distance between each two adjacent ribs may be in the range between 20 mm and 100 mm inclusive.

The ribs may each extend longitudinally parallel to a main extension plane of the spacer element. The transverse direction may be parallel to the main extension plane and, accordingly, the vertical direction may be perpendicular to the main extension plane.

The spacer element may be an essentially 2-dimensional element. This means that the thickness of the spacer element, measured perpendicularly to its main extension plane, may be smaller than its smallest extension along the main extension plane. The thickness of the whole spacer element is, e.g., mainly defined by the thickness of ribs. By way of example, the thickness of the spacer element is at most 150% or at most 120% of the thickness of a rib.

Some or all ribs may run parallel to each other or may at least be orientated similarly. For example, the main extension directions of each two adjacent ribs enclose an angle of at most 30° or most 10° or at most 5°. Some or all ribs may be straight, i.e., extend along a longitudinal axis.

The spacer element may be arrangeable between two successive winding units of the winding. This means that the spacer element as a unit, namely with the compound of ribs and connection member, is arrangeable between two successive winding units. In other words, the ribs and the connection member are arranged simultaneously between the successive winding units. For example, the spacer element can be placed on top of a winding unit of the winding after forming this winding unit and before forming the next winding unit.

The spacer element is, e.g., an element separately manageable or separately arrangeable, respectively, from any electrical conductor of the winding. In other words, the spacer element does not comprise any electrical conductors of the winding and, before arranged in the winding, the spacer element is not mechanically connected to any electrical conductor of the winding.

A winding unit is as a portion of the winding comprising one or more electrical conductors. It may comprise one or several turns of one or more electrical conductors. A winding unit may comprise a bundle of conductors, which are, e.g., twisted. For example, a winding unit is formed as a disk or is a section of a helical winding (winding section). During operation of the winding, electrical current is running through each winding unit.

The successive winding units may be successive in an axial direction. An axial direction of the winding is, e.g., a direction along the winding axis around which the winding is wound. This winding axis may be a main extension axis of the winding. A radial direction is then defined as a direction perpendicular to the axial direction and through the winding axis. A radial inward direction is a direction pointing towards the winding axis and a radial outward direction is a direction pointing away from the winding axis. Moreover, a circumferential direction, also referred to as an azimuthal direction, is then defined as a direction perpendicular to the axial direction and perpendicular to the radial direction(s). The circumferential direction is, e.g., a direction parallel to a main extension direction of the winding unit.

When arranged between two successive winding units of the winding, the spacer element may separate and/or electrically isolate the two successive winding units from each other. For example, the winding units may then be in direct mechanical contact with the spacer element.

Each two adjacent ribs delimit a flow channel for a cooling fluid. Said flow channel may extend between and along the two adjacent ribs. Thus, the length of the flow channels may each be defined by the lengths of the ribs delimiting said flow channel. The two adjacent ribs may delimit the flow channel in transverse direction and/or in a direction parallel to the main extension plane of the spacer element. The thickness or height of the flow channel may be defined by the thickness of the ribs. The width of the flow channel may be defined by the distance between the two adjacent ribs. All features disclosed in connection with one pair of adjacent ribs are also disclosed for all other pairs of adjacent ribs.

The flow channel may be open at both longitudinal ends so that fluid can enter and leave the flow channel at opposite longitudinal ends with a flow direction along a main extension direction of the flow channel.

When the spacer element is arranged between two successive winding units, the ribs may delimit the flow channels in a direction parallel to a main extension direction of the winding units, e.g., in circumferential direction. The flow channels may extend at least partially in radial direction. For example, each flow channel has a main extension direction which encloses an angle of at most 60° or at most 45° or at most 30° with the radial direction. In the direction perpendicular to the winding units, e.g., in axial direction, the flow channel may be delimited by at least one winding unit and/or the at least one connection member.

The flow channel is configured for a cooling fluid to flow through it. The cooling fluid may be a liquid or a gas. For example, the cooling fluid is oil or water or air.

According to a further embodiment, the spacer element is shaped as a ring or as a ring segment. The ring may be a circular ring or an elliptical ring or a rectangular ring. For example, in plan view of the main extension plane of the spacer element, the spacer element is shaped as such a ring or ring segment, i.e., delimited by a contour of a ring or ring segment. For instance, the spacer element is shaped as an eighths ring or a quarter ring or a half ring or full ring.

The ribs may extend from the inner radial contour of the ring segment towards or until the outer radial contour. Additionally or alternatively, the ribs may extend from the outer radial contour of the ring segment towards or until the inner radial contour. A radial contour is herein the part of the contour delimiting the spacer element in radial direction. The radial direction is a direction through the middle point of the ring of which the spacer element forms a ring segment. The circumferential or azimuthal direction, respectively, is perpendicular to the radial direction.

When arranged between the winding units, the radial direction defined above for the winding and the radial direction defined here for the ring segment may coincide. The same is true for the circumferential directions. The ring width of the spacer element may be adapted to the ring widths of the winding units, e.g., may deviate from the widths of the winding units by at most 30%.

According to a further embodiment, two adjacent ribs extend obliquely or perpendicularly with respect to a straight connection line connecting first longitudinal ends of the two adjacent ribs. The first longitudinal ends of the two adjacent ribs may be the two longitudinal ends of the ribs which are closest to each other. For example, the two first longitudinal ends are closest to the inner radial contour of the spacer element.

For example, an angle between the main extension directions of the two adjacent ribs and the straight line is between 10° and 90° inclusive, e.g., between 10° and 80° inclusive or between 60° and 80° inclusive. When axially arranged between two successive winding units, the ribs may extend perpendicularly to the axial direction. The ribs may either extend parallel or obliquely to the radial direction. For example, an angle between the main extension direction of the ribs and the radial direction is between 10° and 90° inclusive or between 10° and 80° inclusive or between 10° and 30° inclusive.

The flow channels may extend over the whole width of the spacer element. The width of the spacer element is herein defined as the extension of the spacer element in a direction perpendicular to the straight connection line and running parallel to the main extension plane of the spacer element.

According to a further embodiment, the two adjacent ribs partially overlap in direction of the straight connection line. In other words, when the two adjacent ribs are projected onto the straight connection line, sections of the projected ribs overlap with each other. For example, the sections of the projected ribs overlapping with each other have a lengths which are at least one quarter or at least one third of the total lengths of the ribs. Such a design of the ribs may be advantageous for the mechanical stability.

According to a further embodiment, the spacer element comprises at least two connection members spaced from each other and extending obliquely or perpendicularly to the ribs. The spacer element may comprise exactly two or more than two connection members. The connection members may form a frame structure, e.g., a frame around the ribs.

The connection members may each be an elongated element with a length greater than a width and greater than a thickness. The main extension directions of the at least two connection members may run oblique or perpendicular to the main extension directions of the ribs. The main extension directions of the connection members may be parallel to the main extension plane of the spacer element. For example, thicknesses and widths of the connection members measured perpendicularly to the respective main extension direction are at most 25% or at most 10% of the lengths of the connection members. For example, the connection members are each cylindrically shaped.

The at least two connection members may each extend parallel to the inner and outer radial contour of the spacer element. For instance, connection members are arranged parallel to each other.

According to a further embodiment, the at least two connection members are each connected to each of the ribs. Thus, each of the two connection members extends over each of the ribs.

According to a further embodiment, at least one of the connection members is connected to longitudinal ends of the ribs, e.g., of each rib. For example, one connection member is connected to the first longitudinal ends of the ribs and the other connection member is connected to the opposite, second longitudinal ends of the ribs.

The spacer element may comprise more three or more connection members. One of the connection members may be connected to the ribs in an area spaced from the longitudinal ends, e.g., to the center of the ribs. This connection member may then be arranged between the connection members connected to the longitudinal ends.

According to a further embodiment, at least one connection member, e.g., each connection member, has as smaller thickness than the ribs, e.g., at most half the thickness or at most ¼ of the thickness. The thickness of a connection member is measured in the same direction as the thicknesses of the ribs, e.g., perpendicularly to the main extension plane of the spacer element.

According to a further embodiment, the connection member having a smaller thickness than the ribs, e.g., each connection member having a smaller thickness than the ribs, is connected to the ribs at half their thickness. Thus, a cooling fluid can run along the flow channel and pass the connection member(s) above and below the connection member(s). This can improve the flow of the cooling fluid and therefore improve the cooling.

The flow channels may be at least partially open in a direction perpendicular to the main extension plane of the spacer element. Only when the spacer element is arranged between the winding units, are the flow channels delimited in this direction by the winding units.

According to a further embodiment, the at least one connection member is a carrier. The carrier may be a plate-like or 2-dimensional element. A main extension plane of the carrier may run parallel to a main extension plane of the whole spacer element. The carrier may be a contiguous element without interruptions.

According to a further embodiment, the ribs are arranged on the carrier, e.g., on a top side of the carrier. For example, in plan view of the main extension plane of the spacer element, each rib completely overlaps with the carrier, i.e., over the whole length of the rib. Likewise, the carrier may overlap with the whole flow channel formed between each pair of adjacent ribs. Thus, in at least one direction perpendicular to the main extension plane of the spacer element, each flow channel may be completely delimited by the carrier. The carrier is, e.g., formed of paper or pressboard.

According to a further embodiment, the at least one connection member and the ribs are integrally formed. For example, the at least one connection member and the ribs are formed in one piece. For example, the compound of the ribs and the connection member or the whole spacer element is formed by an additive manufacturing method, like 3-D printing, or by an extrusion method or by molding.

According to a further embodiment, the spacer element further comprises at least one connection feature, i.e., one or more connection features. All features disclosed in connection with one connection feature are also disclosed for all other connection features. The connection feature is configured to form a form-fitting connection to a further element of the electric device or of the winding. For example, the connection feature is configured to engage with a corresponding connection feature of the further element.

The connection feature may be a recess or a protrusion configured to engage with a protrusion or recess, respectively, of the further element. For example, the connection feature is formed like a nose or a nose hole of a jigsaw puzzle. The connection feature may comprise an undercut. The further element may be a further spacer element or an inner winding cylinder or an outer winding cylinder.

According to a further embodiment, the spacer element comprises a closed region at one longitudinal end of the flow channels. The closed region may delimit the flow channels in their main extension directions. The closed region may be formed of a solid material. It may extend over all ribs or flow channels, respectively. The closed region is, e.g., formed contiguously, e.g., without interruptions. For instance, the closed region comprises or forms one of the connection members. The closed region may be formed integrally and/or in one piece with the ribs.

For example, the closed region is arranged at the inner radial contour or the outer radial contour. The closed region may extend over the whole inner radial contour or the whole outer radial contour, respectively. The closed region may be ring segment shaped, i.e., when viewed in plan view of the main extension plane of the spacer element, the closed region has the shape of a ring segment.

The closed region may have the same thickness as the ribs, i.e., the same thickness within the limits of the manufacturing tolerance. A width of the closed region, measured in the same direction as the width of the whole spacer element, is, e.g., at least 10% or at least 25% of the width of the spacer element.

According to a further embodiment, the closed region is configured to prevent the flow of the cooling fluid in a direction perpendicular to the flow channels, e.g., perpendicular to the main extension plane of the spacer element. When arranged between two winding units, the closed region may prevent a flow of the cooling fluid in axial direction.

The closed region is particularly a region of the spacer element configured to radially project beyond the winding units of the winding either in radial inward or radial outward direction. An axial flow channel of the winding can then be interrupted or closed by the closed region.

Next, the kit is specified.

According to an embodiment, the kit comprises a plurality of spacer elements according to any one of the embodiments described herein. For example, the kit comprises at least 10 or at least 50 of such spacer elements.

According to a further embodiment, a first spacer element of the plurality of spacer elements has a smaller width than a second spacer element of the plurality of spacer elements. For instance, when the spacer elements are arranged in the winding, the first spacer element has a smaller radial extension than a second spacer element. For example, the second spacer element is formed such that it radially projects beyond the winding units, e.g., in radial inward or radial outward direction. The second spacer element may have a greater width than the winding units. A width of a winding unit is measured in the same direction as the width of the spacer element and/or is measured in radial direction. The first spacer element may have a smaller width than the winding units.

According to a further embodiment, the second spacer element is a spacer element with a closed region. For example, the second spacer element is configured such that at least a portion of the closed region projects beyond the winding units in radial inward or radial outward direction.

The first spacer element may be a spacer element with flow channels which are open at their longitudinal ends so that a cooling fluid can enter the flow channels at one longitudinal end and can leave the flow channels at an opposite longitudinal end in a direction along the flow channel. For example, the first spacer element is a spacer element where the flow channels and/or the ribs extend over the entire width of the spacer element.

The kit may comprise a plurality of first spacer elements and/or a plurality of second spacer elements. For example, the kit comprises more first spacer elements than second spacer elements. All features disclosed in connection with one first spacer element or one second spacer element are also disclosed for all other first or second spacer elements, respectively.

Next, the method for manufacturing a winding for an electric device is specified.

According to an embodiment, the method comprises a step in which a spacer element according to any one of the embodiments described herein is arranged on a winding unit of the winding in stacking direction. The method further comprises a step, in which a successive winding unit is formed on the spacer element in stacking direction so that the spacer element spaces the winding unit and the successive winding unit from each other in stacking direction.

The stacking direction may be identical to the axial direction of the winding. In the step of arranging a spacer element on a winding unit, a plurality of spacer elements may be arranged on the winding unit. For instance, for performing the method, a kit according to any of the embodiments described herein is provided.

The spacer elements may be arranged on the winding unit and may be arranged spaced from each other in circumferential direction or may be connected to each other, e.g., form-fittingly, by means of the connection features. Additionally or alternatively, the spacer elements may be connected to an outer winding cylinder and/or and inner winding cylinder of the winding by means of the connection features. The one or more spacer elements may be arranged directly on the winding unit.

When forming the successive winding unit, one or more turns of the winding unit may be laid over the spacer element(s). The successive winding unit may be formed directly on the one or more spacer elements.

Next, the winding for an electric device is specified. The winding may be produced with the method specified above. Therefore, all features disclosed in connection with the method are also disclosed for the winding and vice versa.

According to an embodiment, the winding comprises a plurality of successive, e.g., axially successive, winding units. Furthermore, the winding comprises at least one spacer element, i.e., one or more spacer elements, according to any one of the embodiments described herein. The at least one spacer element is arranged, e.g., axially arranged, between two successive winding units.

When arranged between the winding units, each two adjacent ribs of the at least one spacer element may delimit a flow channel for a cooling fluid in circumferential direction. For example, the flow channels extend at least partially in radial direction. The ribs of the at least one spacer element may be aligned in axial direction.

According to a further embodiment, the winding comprises at least one first spacer element and at least one second spacer element which are both arranged between successive winding units. The second spacer element has a greater width, e.g., a greater radial extension, than the first spacer element. For example, the second spacer element is a spacer element with a closed region as specified above.

According to a further embodiment, the closed region projects beyond the winding units in order to prevent a flow of a cooling fluid in a direction perpendicular to the flow channels, i.e., perpendicular to the main extension direction of the flow channels. The closed region of the second spacer element may project beyond the winding units in radial direction, e.g., in radial inward or radial outward direction, and may prevent an axial flow of a cooling fluid.

For example, the closed region projects into an axial flow channel of the winding. The axial flow channel may be formed between the winding units and the outer or inner winding cylinder, thus may be an inner or outer axial flow channel. For example, the closed region of the second spacer element extends until the inner or outer winding cylinder, i.e., over the whole radial extension of the axial flow channel.

For example, the first spacer element is arranged between a different pair of successive winding units than the second spacer element. The first spacer element and the second spacer element may lie at different heights with respect to the axial direction.

The winding may comprise a plurality of first spacer elements and/or a plurality of second spacer elements. For example, in axial direction, one or more first spacer elements are arranged between each pair of second spacer elements. For each pair of closest second spacer elements, the closed region of one of the second spacer elements may project beyond the winding units in radial inward direction and the closed region of the other one of the second spacer elements may project beyond the winding units in radial outward direction in order to alternatingly close or interrupt the inner and outer axial flow channels. In this way a meander-shaped flow channel for the cooling fluid may be created.

The spacer element may be provided in form of an elongated band. This band may be bendable or rollable, for instance such that it can be provided rolled up on a roll. In order to perform the method described above, a part of the band may be divided into appropriate smaller pieces wherein each piece then constitutes a spacer element as described above.

### BRIEF DESCRIPTION OF THE DRAWINGS

Hereinafter, the spacer element for a winding, the method for manufacturing a winding and the winding will be explained in more detail with reference to the drawings on the basis of exemplary embodiments. The accompanying figures are included to provide a further understanding. In the figures, elements of the same structure and/or functionality may be referenced by the same reference signs. It is to be understood that the exemplary embodiments shown in the figures are illustrative representations and are not necessarily drawn to scale. In so far as elements or components correspond to one another in terms of their function in different figures, the description thereof is not repeated for each of the following figures. For the sake of clarity, elements might not appear with corresponding reference symbols in all figures.

FIG. 1 shows an exemplary embodiment of the spacer element,

FIG. 2 shows a section of a further exemplary embodiment of the spacer element,

FIGS. 3 to 5 show perspective views of sections of exemplary embodiments of the spacer element,

FIGS. 6 to 8 show further exemplary embodiments of the spacer element,

FIGS. 9 to 11 show exemplary embodiments of a connection feature of the spacer element,

FIGS. 12 to 14 show different positions in an exemplary embodiment of the method for manufacturing a winding,

FIG. 15 shows a position in a further exemplary embodiment of the method for manufacturing of a winding,

FIGS. 16 and 17 show exemplary embodiments of the winding, and

FIGS. 18 to 21 show further exemplary embodiments of the spacer element.

### DETAILED DESCRIPTION

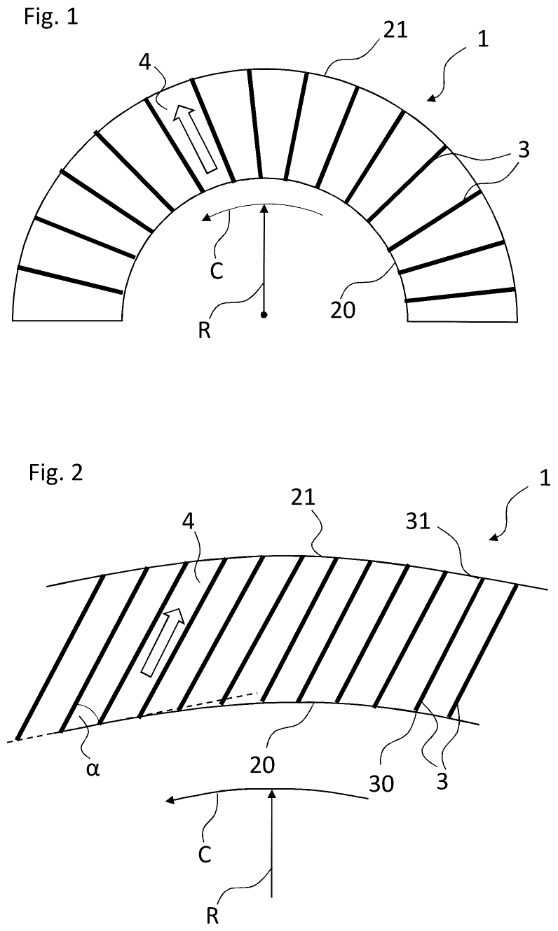

FIG. 1 shows a first exemplary embodiment of the spacer element 1 in plan view of a main extension plane of the spacer element 1. The spacer element 1 comprises two connection members 20, 21 which are connected to a plurality of ribs 3. Here, the spacer element 1 is shaped as a ring segment of a circular ring and the ribs 3 extend in radial direction R from a radial inner contour towards and until a radial outer contour of the spacer element 1. Between each pair of ribs 3, a flow channel 4 is formed which is delimited by the pair of the ribs 3 in circumferential direction C. The flow channels 4 extend along the ribs 3 by which they are delimited. Here, the flow channels 4 also extend radially.

The ribs 3 and the connection member 2 may be formed of electrically isolating material, e.g., plastic. For example, the ribs 3 and the connection member 2 are integrally formed or in one piece, respectively. The spacer element 1 may be formed by additive manufacturing, like 3-D printing.

The circular ring segment shape of FIG. 1 is an example. Alternatively, the spacer element 1 could also be shaped as a segment of a rectangular ring or an elliptical ring when seen in plan view. Also the shape of a complete ring is possible.

FIG. 2 shows a section of a further exemplary embodiment of the spacer element 1 in plan view of the main extension plane of the spacer element 1. Again, the spacer element 1 is ring segment shaped. The ribs 3 are all arranged parallel to each other. Here, each two adjacent ribs 3 extend obliquely to a straight connection line connecting first longitudinal ends of the adjacent ribs 3. The straight connection line assigned to the second and third rib 3 as seen from the left side is indicated by the dashed line. The angle a between the main extension directions of the ribs 3 and the straight connection line is, e.g., between 60° and 80° inclusive. Accordingly, the flow channels 4 are orientated in a direction which is oblique to the radial direction R, i.e., extends under an acute angle with respect to the radial direction R.

As can be further be seen in FIG. 2, due to the lengths and due to the angle α being smaller than 90°, each two adjacent ribs 3 overlap with each other along the straight connection line. In other words, when projecting the ribs 3 onto the straight connection line, the projected ribs 3 partially overlap with each other. Such an arrangement can be advantageous with respect to the mechanical stability when the spacer element 1 is arranged between two successive winding units.

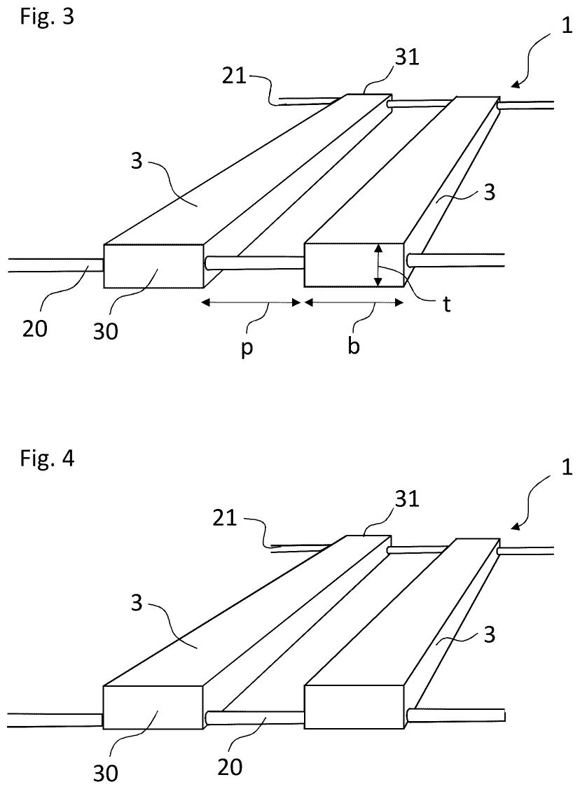

FIG. 3 shows a section of an exemplary embodiment of the spacer element 1 in a perspective view. For example, a section of FIG. 2 is illustrated. As can be seen, there are two connection members 20, 21 which are each connected to the ribs 3. The first connection member 20 is connected to the ribs 3 at first longitudinal ends 30 and the second connection member 21 is connected to the ribs 3 at opposite second longitudinal ends 31. The connection members 20, 21 are longitudinal, cylindrically shaped elements extending obliquely to the ribs 3 and running essentially parallel to each other. The connection member 20, 21 can be called bar shaped or stick shaped or rib shaped.

In FIG. 3, the ribs 3 each have a width b and a thickness t. For example, the thickness t is at least 2 mm and at most 5 mm. The widths b may be at least 20 mm and at most 50 mm for each rib 3. The distance or pitch p between the two adjacent ribs 3 is, e.g., greater than the width b of the ribs 3.

As can be further seen in FIG. 3, the thickness of the connection members 20, 21, measured in the same direction as the thickness t of the ribs 3, is smaller than the thickness t of the ribs 3. The connection members 20, 21 are connected to the longitudinal ends 30, 31 of the ribs 3 at about half their thickness t. This is advantageous in terms of a good fluid flow along the flow channels 4 between the ribs 3.

In FIG. 4, in contrast to what is shown in FIG. 3, the connection members 20, 21 are not arranged at about half the thickness of the ribs 3, but in the region of the bottom sides of the ribs 3.

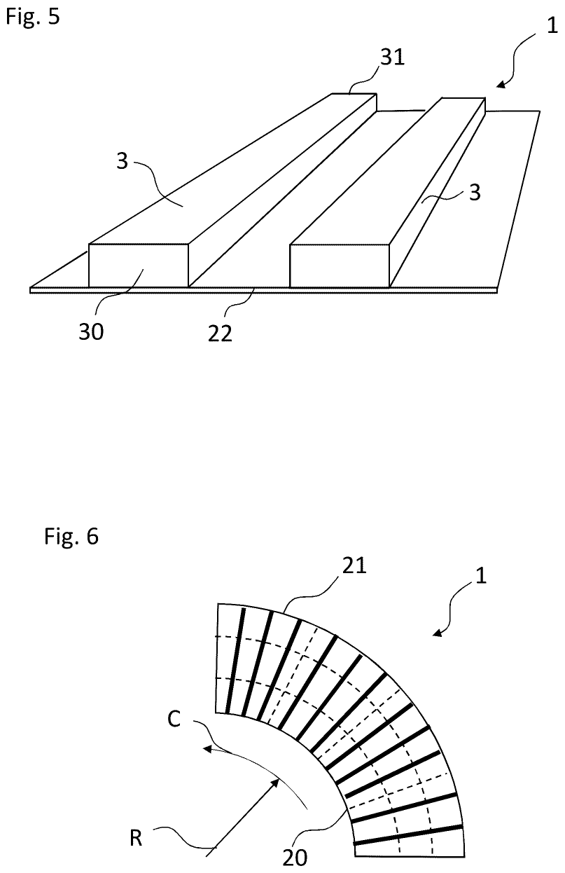

In FIG. 5, there is only one connection member 22 in the form of a carrier 22 on which the ribs 3 are arranged. The carrier 22 extends over the whole lengths of the ribs 3 and between the ribs 3. The carrier 22 is a plate-like element and may be formed, e.g., of paper or pressboard.

FIG. 6 shows a further exemplary embodiment of the spacer element 1 in plan view of to the main extension plane of the spacer element 1. In FIG. 6, the spacer element 1 is provided with a plurality of separation lines extending in circumferential direction C and radial direction R (dashed lines). The separation lines are regions where the spacer element 1 can be divided in order to obtain smaller spacer elements 1. The separation lines may be optically indicated to a user and may be drawn onto the spacer element 1 in order to allow the spacer element 1 to be cut along these lines. Alternatively, the separation lines may be realized as perforations in the spacer element 1, e.g., in order to allow breaking along these lines. Thus, the separation lines may be predetermined breaking lines.

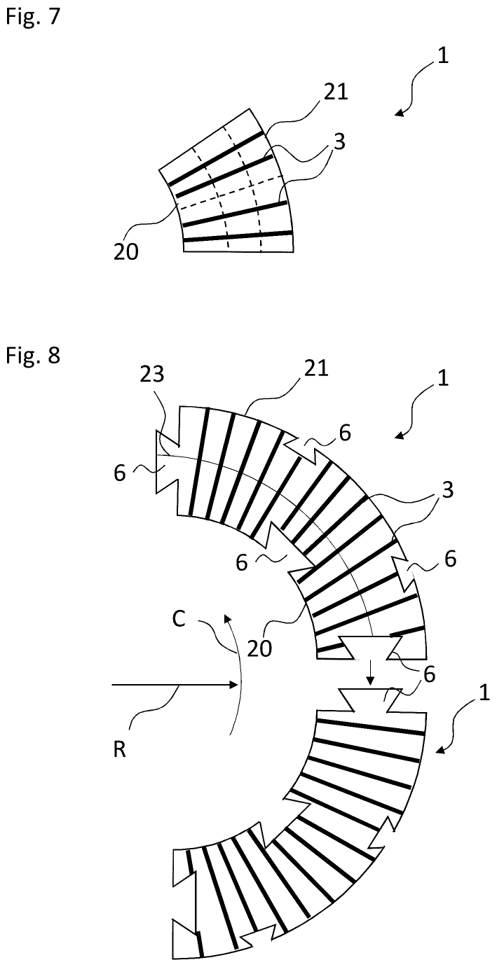

FIG. 7 shows a spacer element 1 which differs from the spacer element 1 of FIG. 6 in that instead of the spacer element being shaped as a quarter ring segment, the spacer element is now shaped as an eighths ring segment. This may be achieved, e.g., by dividing the spacer element 1 of FIG. 6 along the radially extending separation line in the middle.

The separation lines described in connection with FIGS. 6 and 7 may be realized in every embodiment of a spacer element 1, even if not explicitly shown.

FIG. 8 shows an exemplary embodiment of two spacer elements 1 in plan view of their respective main extension plane. Each spacer element 1 is quarter ring segment shaped and comprises a plurality of ribs 3. Each spacer element 1 comprises a plurality of connection features 6. Connection features 6 at the inner and outer radial contour of the spacer elements 1 are formed as recesses 6 with an undercut. At one circumferential end, each spacer element 1 comprises a connection feature 6 in the form of a recess and at the opposite circumferential end, the spacer elements 1 comprise a connection feature 6 in form of a protrusion. The protrusion is configured to engage the recess of a further spacer element 1 so that the spacer elements 1 can be form-fittingly connected to each other, e.g., in order to form a larger ring segment shaped spacer element 1. The connection features 6 at the radial contours of the spacer elements 1 are configured, e.g., to engage with corresponding connection features of inner and outer winding cylinders.

As can be further seen in FIG. 8, one of the spacer elements 1 comprises a third connection member 23 shaped as the first 20 and second 21 connection members and being arranged radially between them. The third connection member 23 is, e.g., connected to the ribs 3 at a respective center thereof. Such a third connection member could be used in every of the embodiments described herein.

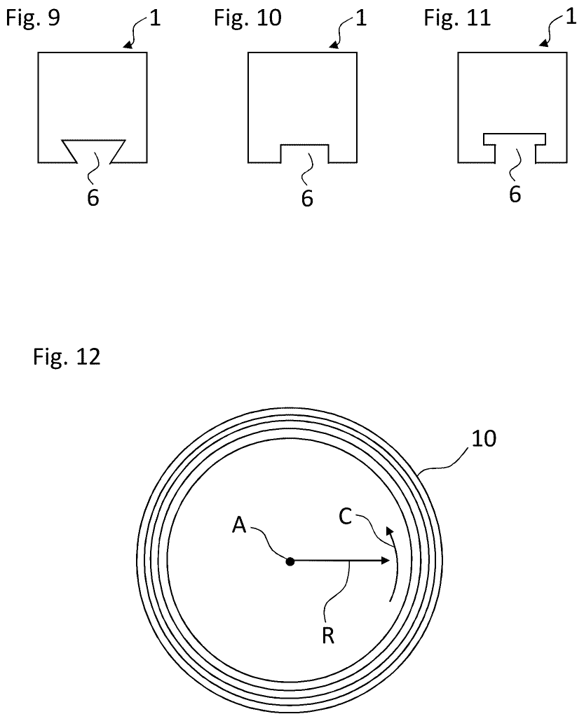

FIGS. 9 to 11 show exemplary embodiments of the connection features 6, particularly different forms of the connection features 6. In FIGS. 9 and 11, the connection features 6 are realized as recesses having an undercut whereas, in FIG. 10, the recess 6 does not have an undercut but is a rectangularly shaped recess.

FIG. 12 shows a position in an exemplary embodiment of the method for manufacturing a winding. In FIG. 1, a winding unit 10 comprising a plurality of turns of one or more conductors is shown. The winding unit 10 is shown in plan view. An axial direction A extends perpendicularly to the drawing plane. The radial direction R and the circumferential direction C are indicated as well.

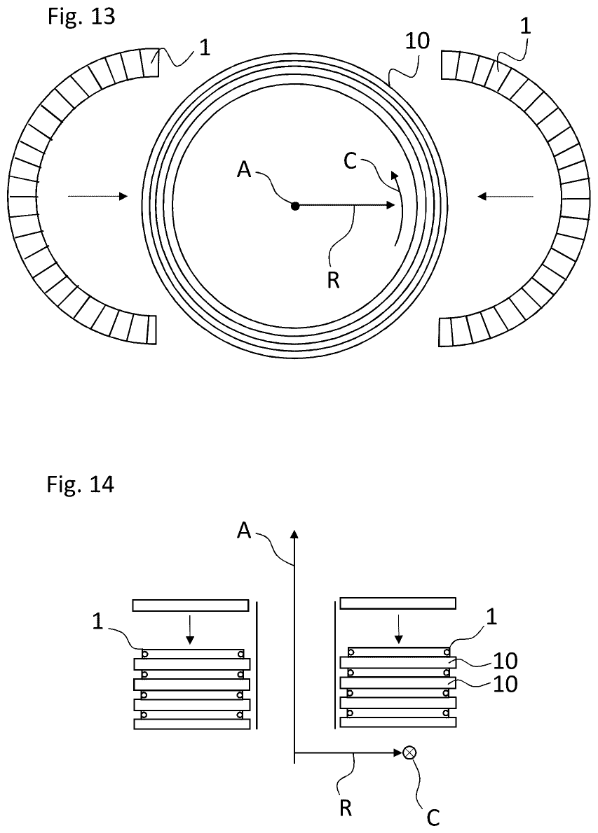

FIG. 13 shows a position in the method where two half ring shaped spacer elements 1 are arranged on top of the winding unit 10.

FIG. 14 shows a position after the spacer elements 1 have been attached to the winding unit 10. Here, a cross-sectional view is shown. FIG. 14 also illustrates a step in which a further winding unit 10 is formed on the spacer elements 1. The spacer elements 1 axially separate the axially successive winding units 10 from each other.

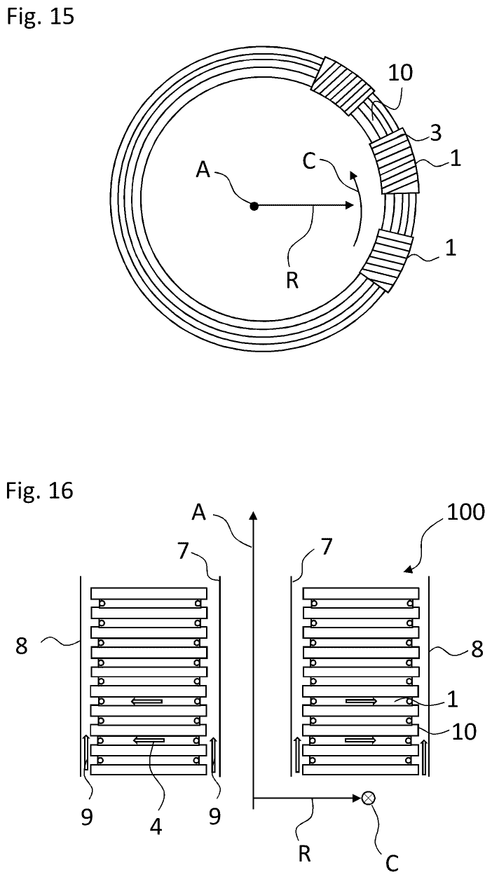

FIG. 15 shows a position in a further exemplary embodiment of the method in which, instead of half ring shaped spacer elements 1, the spacer elements 1 are formed as smaller ring segments and are arranged on the winding unit 10 spaced from each other in circumferential direction C.

In FIG. 16, an exemplary embodiment of a winding 100 for an electric device, e.g., for a power transformer, is shown. The winding 100 comprises a plurality of winding units 10 which are stacked on top of each other. The winding units 10 are axially spaced from each other by the spacer elements 1. The spacer elements 1 each comprise a plurality of flow channels 4 allowing a fluid flow between two axial flow channels 9. The two axial flow channels 9 are radially spaced from each other and the winding units 10 as well as the spacer elements 1 are arranged between the two axial flow channels 9 in radial direction.

The winding 100 of FIG. 16 comprises an inner winding cylinder 7 and an outer winding cylinder 8 with the winding units 10 and the spacer elements 1 arranged radially in between. Between the winding cylinders 7, 8 and the winding units 10, the axial flow channels 9 are formed. The spacer elements 1 may be form-fittingly connected to the winding cylinders 7, 8 by means of the connection features 6 described in connection with FIG. 8.

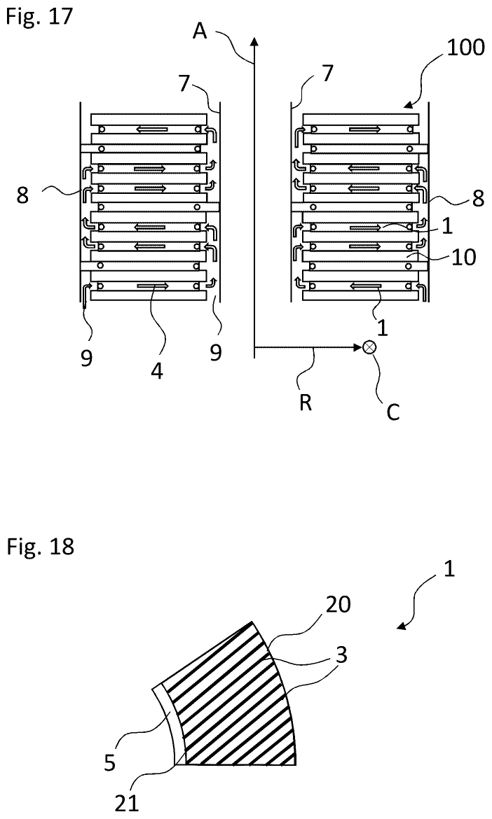

In FIG. 17, a further exemplary embodiment of a winding 100, e.g., for a power transformer, is shown. Here, the winding 100 comprises first and second spacer elements 1. The first spacer elements 1 are formed as in FIG. 16 and provide flow channels 4 for exchanging fluid between the axial flow channels 9. The second spacer elements 1 each have a larger width than the first spacer elements 1 and project beyond the winding units 10 either in radial outward or in radial inward direction. Here, the second spacer elements 1 are arranged in an alternating manner so that second spacer elements 1 projecting in radial outward direction alternate with second spacer elements 1 projecting in radial inward direction. The projecting portion of the second spacer elements 1 is realized by closed regions which prevent a flow of the cooling fluid in axial direction as can be seen in FIG. 17. In this way, the cooling fluid can be guided from the inner axial flow channel 9 to the outer axial flow channel 9 through the flow channels 4.

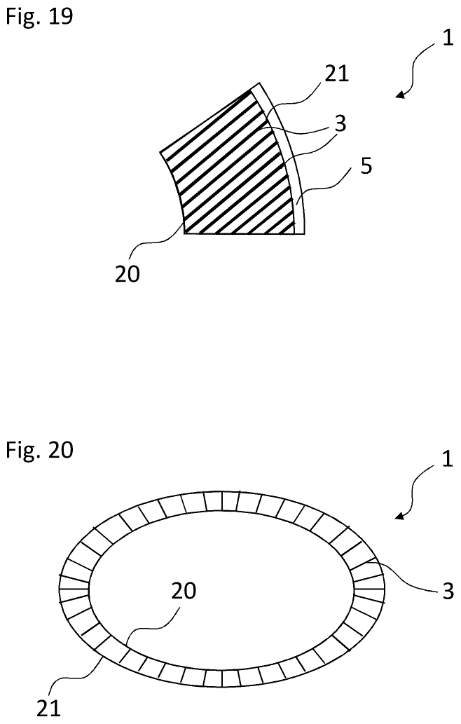

Exemplary embodiments of the second spacer elements 1 are shown in FIGS. 18 and 19. In FIG. 18, the closed region 5 is arranged at the radial inner contour of the spacer element 1 and, in FIG. 19, the closed region 5 is arranged at the radial outer contour of the spacer element 1. The closed regions 5 are each realized as a ring segment. They are formed of a solid material and are formed contiguously without interruptions so that a cooling fluid cannot pass through the closed regions 5 in axial direction.

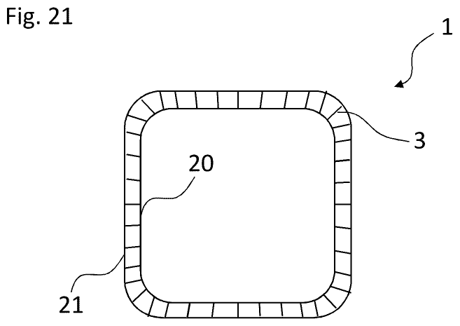

FIGS. 20 and 21 show further exemplary embodiments of spacer elements. In FIG. 20, the spacer element 1 is shaped as an elliptical ring but, instead, could also be shaped as a segment of such an elliptical ring. In FIG. 21, the spacer element 1 is shaped as a rectangular ring but, instead, could also be shaped as segment of such a rectangular ring.

The embodiments shown in the figures represent exemplary embodiments of the spacer element, the method for manufacturing a winding and of the winding. Therefore, they do not constitute a complete list of all embodiments according to the spacer element, the method for manufacturing a winding and of the winding. Actual spacer elements, methods and windings may vary from the embodiments shown in terms of arrangements, devices and elements for example.

### REFERENCE SIGNS

1 spacer element
3 rib
4 flow channel
5 closed region
6 connection feature
7 inner cylinder
8 outer cylinder
9 flow channel
10 winding unit
20 first connection member
21 second connection member
22 carrier
23 third connection member
30 first longitudinal end
31 second longitudinal end
100 winding
A axial direction
R radial direction
c circumferential direction
α angle
b width
t thickness
P pitch

1-14. (canceled)

15. A spacer element for a winding of an electric device comprising:
at least one connection member,
a plurality of straight ribs, and
at least one connection feature for forming a form-fitting connection to a connection feature of a further element of the electric device, wherein
the ribs are connected to the connection member and are spaced from each other pairwise,
the spacer element is arrangeable between two axially successive winding units of the winding during manufacturing of the winding,
each two adjacent ribs delimit a flow channel for a cooling fluid, said flow channel extends between and along the two adjacent ribs and extends at least partially in radial direction,
two adjacent ribs extend obliquely with respect to a straight connection line connecting first longitudinal ends of the two adjacent ribs,
the two adjacent ribs run parallel to each other or are at least orientated similarly so that an angle between the main extension directions of the two adjacent ribs enclose an angle of at most 30° and so that the two adjacent ribs partially overlap in direction of the straight connection line.

16. The spacer element according to claim 15, wherein
the spacer element is shaped as a ring or a ring segment.

17. The spacer element according to claim 15, comprising
at least two connection members spaced from each other and extending obliquely to the ribs,
the at least two connection members are each connected to each of the ribs.

18. The spacer element according to claim 17, wherein
at least one of the connection members is connected to longitudinal ends of the ribs.

19. The spacer element according to claim 17, wherein
at least one connection member has a smaller thickness than the ribs,
this connection member is connected to the ribs at half their thickness.

20. The spacer element according to claim 15, wherein
the at least one connection member is a carrier,
the ribs are arranged on the carrier.

21. The spacer element according to claim 15, wherein
the at least one connection member and the ribs are integrally formed.

22. The spacer element according to claim 15, comprising
a closed region at one longitudinal end of the flow channels,
the closed region is configured to prevent a flow of the cooling fluid in a direction perpendicular to the flow channels.

23. A kit with a plurality of spacer elements, wherein
for each spacer element
the spacer element has at least one connection member,
the spacer element has a plurality of straight ribs, wherein
the ribs are connected to the connection member and are spaced from each other pairwise,
the spacer element is arrangeable between two axially successive winding units of the winding during manufacturing of the winding,
each two adjacent ribs delimit a flow channel for a cooling fluid, said flow channel extends between and along the two adjacent ribs and extends at least partially in radial direction,
two adjacent ribs extend obliquely with respect to a straight connection line connecting first longitudinal ends of the two adjacent ribs,
the two adjacent ribs run parallel to each other or are at least orientated similarly so that an angle between the main extension directions of the two adjacent ribs enclose an angle of at most 30° and so that the two adjacent ribs partially overlap in direction of the straight connection line,
a first spacer element of the plurality of spacer elements has a smaller width than a second spacer element of the plurality of spacer elements,
the second spacer element has a closed region at one longitudinal end of the flow channels and the closed region is configured to prevent a flow of the cooling fluid in a direction perpendicular to the flow channels.

24. A method for manufacturing a winding for an electric device, comprising:
arranging a spacer element according claim 15 on a winding unit of the winding in a stacking direction, wherein the stacking direction is the axial direction of the winding,
forming a successive winding unit of the winding in stacking direction on the spacer element so that the spacer element spaces the winding unit and the successive winding unit in stacking direction from each other.

25. A winding for an electric device, comprising:
a plurality of axially successive winding units,
at least one first spacer element and at least one second spacer element both arranged between successive winding units, wherein
for each spacer element
the spacer element has at least one connection member,
the spacer element has a plurality of straight ribs, wherein
the ribs are connected to the connection member and are spaced from each other pairwise,
the spacer element is arrangeable between two axially successive winding units of the winding during manufacturing of the winding,
each two adjacent ribs delimit a flow channel for a cooling fluid, said flow channel extends between and along the two adjacent ribs and extends at least partially in radial direction,
two adjacent ribs extend obliquely with respect to a straight connection line connecting first longitudinal ends of the two adjacent ribs,
the two adjacent ribs run parallel to each other or are at least orientated similarly so that an angle between the main extension directions of the two adjacent ribs enclose an angle of at most 30° and so that the two adjacent ribs partially overlap in direction of the straight connection line,
the second spacer element has a greater width than the first spacer element,
the second spacer element has a closed region at one longitudinal end of the flow channels and the closed region is configured to prevent a flow of the cooling fluid in a direction perpendicular to the flow channels,
the closed region projects beyond the winding units in order to prevent a flow of a cooling fluid in a direction perpendicular to the flow channels.
